(19) United States
(12) Patent Application Publication
(10) Pub. No.: US 2010/0037541 A1
(43) Pub. Date: Feb. 18, 2010

(54) Roof top wind generator

(76) Inventor: Glen Kane, Rapid City, SD (US)

Correspondence Address: Glen Kane, 22922 Flume Lane, Rapid City, SD, 57702, US

(21) Appl. No.: 12/456,400

(22) Filed: Aug. 6, 2009

Related U.S. Application Data
(60) Provisional application No. 61/133,043, filed on Jun. 26, 2008.

(51) Int. Cl. E04D 13/18; F03D 9/00

(52) U.S. Cl. 52/173.1; 290/55

(57) ABSTRACT

The roof top wind generator is design to mount on the ridge of a roof to capture the wind energy without any obtrusive towers or unpleasant looking structures or equipment. The basic design is a multi-fin turbine, built into a roof cap design.

When the wind hits the flat surface of the pitched roof it moves up the roof to the peak much like the wind currents over a airplane wing. When this happens the wind speed is increased to nearly double the velocity at the peak. The roof top wind generator captures that increased wind velocity as it moves over the peak to increases the effectiveness of the wind generator.

The roof top wind generator is design to mount on the ridge of a roof to capture the wind energy without any obtrusive towers or unpleasant looking structures or equipment. The roof top wind generator will come in lengths as short as 2 feet and as long as 10 feet. The basic design is a multi-fin turbine sometimes referred to as a squirrel cage, built in a roof cap design with sheet metal. The units can be painted or a pre-finished color can be applied by the manufacture. These sections are designed to interlock and plug into each other and to adapt to any ridge length. This system can be used in place of other ridge cap roofing systems. It can also be added as a retrofit as long as it is fastened to manufactures specifications. This system can be adapted to mount on most any pitch of roof in commercial or residential applications.

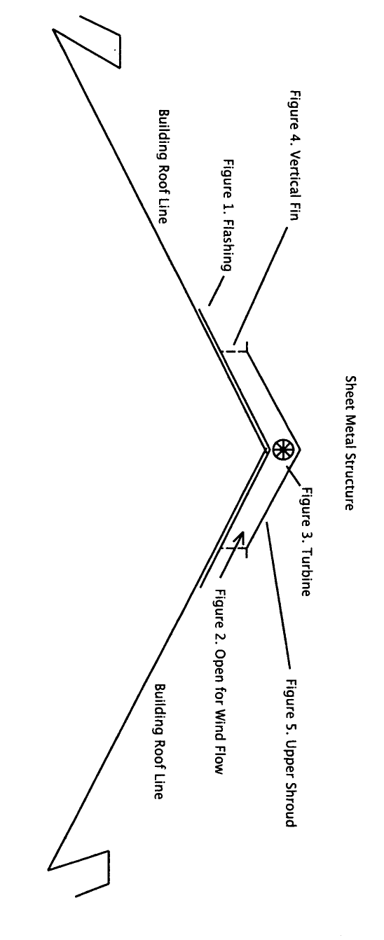

FIG. 1.

The Flashing is a one piece design that goes over the peak in a seamless fashion and laps over the roofing material at the lower edge to create a leak proof system.

FIG. 2.

The opening dimension at the lower edge of the roof top structure where the wind enters will be a minimum of 3 inches and can be ordered up to 12 inches.

FIG. 3.

The multi-fin turbine size is determined by the opening size and ranges from 3 to 12 inches.

FIG. 4.

The vertical pieces that attach the lower flashing to the upper shroud are designed as fins to keep structural integrity, keep birds and other obstruction out of the turbine and also help direct wind currents.

FIG. 5.

The Upper Shroud is also made from sheet metal in a one piece design to protect the Turbine and direct and capture wind flows.

1. This roof top wind generator is unique because it becomes nearly invisible. Many areas have building codes or ordinances that disallow traditional wind generators or turbines due to the unsightly nature of them. The roof top wind generator system may be allowed in these areas because they are virtually invisible. Therefore, it is a vertically invisible wind generator system.

2. When the wind hits the flat surface of the pitched roof it moves up the roof to the peak much like the wind currents over a airplane wing. When this happens the wind speed is increased to nearly double the velocity at the peak. The roof top wind generator captures that increased wind velocity as it moves over the peak. This in turn increases the turbine speed to near double of what it would be away from the roof. This situation in turn nearly doubles the effectiveness of the wind generator.
